(19) United States
(12) Patent Application Publication
(10) Pub. No.: US 2007/0138225 A1
(43) Pub. Date: Jun. 21, 2007

(54) Self-leveling cup holder

(76) Inventor: Martin Duchesne, Brossard (CA)

Correspondence Address: INVENTARIUM, suite 1607, 4050 Rosemont blvd, Montreal, QC, H1X 1M4, US

(21) Appl. No.: 11/599,825

(22) Filed: Nov. 15, 2006

Related U.S. Application Data
(60) Provisional application No. 60/751,562, filed on Dec. 20, 2005.

(51) Int. Cl. B60R 7/00; A47K 1/08; B60R 7/06; B60R 11/00

(52) U.S. Cl. 224/544; 224/483; 224/282; 248/311.2

(57) ABSTRACT

A self-leviling cup holder comprises a combination of two rotational axes that provide for angular compensation means to maintain a cup level as well as keeping the center of gravity of the cup low.

This application claims priority based on provisional application 60/751,562 filed Dec. 20, 2005

### FIELD OF THE INVENTION

The invention relates generally to cup holding devices used in vehicles but more particularly to a cup holder which compensates for centrifugal force as well as hills and other vehicle tilting situations.

### BACKGROUND OF THE INVENTION

Virtually every new vehicle built since the late 20^{th} century comes standard with some form of cup holder, whether a simple round well or a ring or snap that is either hidden away when not in use or generally readily available depending upon the design and room availability of the vehicle.

However, these holders cannot prevent the spillage of liquid when the vehicle is in a position that is other than truly horizontal along both axis (length and width of the vehicle), as well as when taking a curve at a certain rate of speed in which centrifugal force affects the liquid or by braking and accelerating quickly.

Although some patents have adressed that issue in part, such as U.S. Pat. No. 4,721,276 which discloses a device for holding glasses in an upright position.

U.S. Pat. No. 4,724,986 which discloses a beverage receptacle holder for mounting in the interior of a passenger vehicle and which serves to securely hold a beverage receptacle. The holder includes a receptacle receiver having a plurality of spaced-apart, flexible, receptacle-engaging fingers which extend inwardly from the receiver sidewall; a positioning member adjustably coupled to the receiver and adapted for coupling to the vehicles's cigarette lighter socket; and a threaded, stabilizing element coupled to the receiver normal to the axis thereof and adapted for contact with the vehicle dashboard.

U.S. Pat. No. 4,819,843 which discloses a drink container holder having three members: a mounting base having a mounting device for mounting within a vehicle such as an automobile, a holding framework for holding a cup, and an intermediate pivotable framework interposed between the mounting base and the holding framework, the three members being pivotably connected to one another through means of pivotable shaft bearing portions. The mounting device comprises a substantially inverted U-shaped bracket, and the mounting base has dependent bearing portions integrally suspended therefrom.

U.S. Pat. No. 4,826,058 which discloses a drink container holder comprising a storage case built within the body of an automobile, a base framework having an annularly perforated portion able to enter and leave the storage case, an annular holding framework disposed within the perforated portion of the base framework, an intermediate swingable body interposed between the base framework and the holding framework and pivotably attached to the base framework and the holding framework respectively, and a cup holding frame pivotably attached to the holding framework in a suspended fashion.

U.S. Pat. No. 4,877,164 which discloses a holder for cups and similar articles which includes a plurality of elongated articulated members one of which members terminates at one end in an article holding means and at the other end in one-half of an intermeshing pair of joint elements which provide means for forming a positive detent-type joint means. One of the halves of the intermeshing pair of joint elements is in the form of a hub having a plurality of external teeth disposed thereon and the other half of the intermeshing pair of joint elements is in the form of a collar having a plurality of internal teeth arranged and constructed so that the collar fits over the hub element and the respective teeth intermesh to effect an adjustable positive detent joint means. The means for retaining the intermeshing pair of joint elements together includes a pair of spaced-apart leg members extending axially from the hub element and is provided with oppositely directed hook means which snap over and secure the collar half of the joint element to the hub half of the joint element.

U.S. Pat. No. 5,086,958 which discloses an apparatus for use in combination with vehicular cigarette lighter sockets, wherein the apparatus includes a cylindrical base including spring biased clip members to retain the cylindrical base within the cigarette lighter socket. The base is secured to a generaaly “Z” shaped link to define an offset forward leg mounting a first head rotatably mounted to a second head, wherein the second head is in turn mounted to a third head and the third head mounted to a fourth head, the fourth head mounting a support plate thereon, wherein the support plate includes a generally trapezoidal slot to receive trapezoidal flanges of accessories of the organization to include a cup, a clip board organization, and a tray assembly.

The problem is that the center of gravity of the cup when installed into those devices is very high and by leaning in one way or other, it may tip over and spill teh liquid. There is therefore a need for a better cup holder.

### SUMMARY OF THE INVENTION

In view of the foregoing disadvantages inherent in the known devices now present in the prior art, the present invention, which will be described subsequently in greater detail, is to provide objects and advantages which are to provide for a cup holder that compensates for shifts in the horizontal plane due to orientation or centrifugal force but also lowers the center of gravity of the cup so as to obtain true stabilisation.

To attain these ends, the present invention generally comprises an anchoring means which is rotationally and perpendicularly attached to a first axis arm, a sheath that extends perpendicularly from the first axis arm, a second axis arm rotationally and perpendicularly attached to the sheath and a cup support extending integrally and perpendicularly from the second axis arm.

The cup support is so positioned so as to provide for a cup to have its center of gravity below the first axis arm and below the second axis arm's rotational axis. In other words, low enough so that even when the vehicle goes up a hill or banks into a curve, the rotation along both axis won't make the cup tip over simply because it is slung low. There is a counterweight to balance off said cup support which is located at the opposite extremity from the sheath, along the first axis arm.

The first axis arm rotates around a first axis rotational axis point and the first axis rotational axis point extends integrally from the anchoring means.

The self-leveling cup holder can also have a stowable feature in which case the sheath is slidingly attached to the first axis by way of a sleeve, that sleeve being an integral part of the first axis arm. The second axis arm is configured and sized to be insertable into the sheath by sliding through a channel. In this embodiment, the second axis arm is rotationally and perpendicularly attached to the sheath and the sheath has a channel for guiding and allowing insertion of the second axis and the second axis rotational axis pins into the sheath.

In one embodiment, the anchoring means is a cylindrical shape configured and sized to fit into a cigarette lighter hole.

In another embodiment, the anchoring means is at least one clipping means configured for air vents.

In yet another embodiment, the anchoring means is in the shape of a bolt-down plate.

In still another embodiment, the second axis arm is extendable by sliding in and out by way of an extension channel.

In use, turning the second axis arm around its second axis rotational axis point and orienting it so that it is in line with the sheath and pushing the second axis into the sheath by sliding the second axis through the channel allows for stowability of the device is so configured. In general use, inserting a cup into the cup holder is all that is required.

The term cup is used herein for simplicity and refers to all kinds of containers such as, but not limited to, cans, bottles, mugs, glasses, etc.

Although primarily conceived for the automobile industry, this device can also be used on other types of vehicles such as boats.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1a Isometric view of the self-leveling cup holder.

FIGS. 1b-c Detail isometric views of alternate holding means.

FIG. 2 Front view of the self-leveling cup holder rotating along the first axis.

FIG. 3 Side view of the self-leveling cup holder rotating along the second axis.

FIGS. 4ab Side and top views respectively of the sheating action with FIG. 4b showing the self-leveling cup holder recessed.

FIGS. 5a-d Top, front, side views along with a cut along line AA, respectively.

FIG. 6 Front view with the first axis arm and the counterweight hidden behind the dashboard.

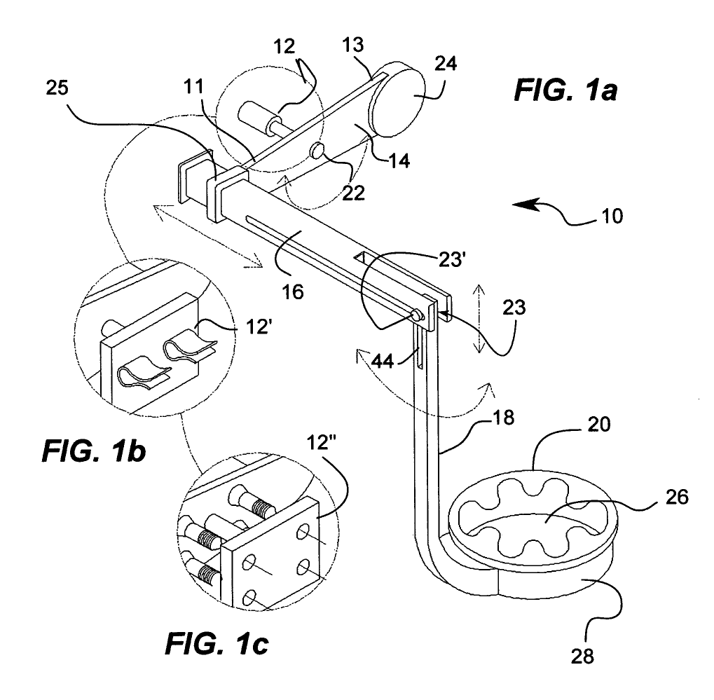

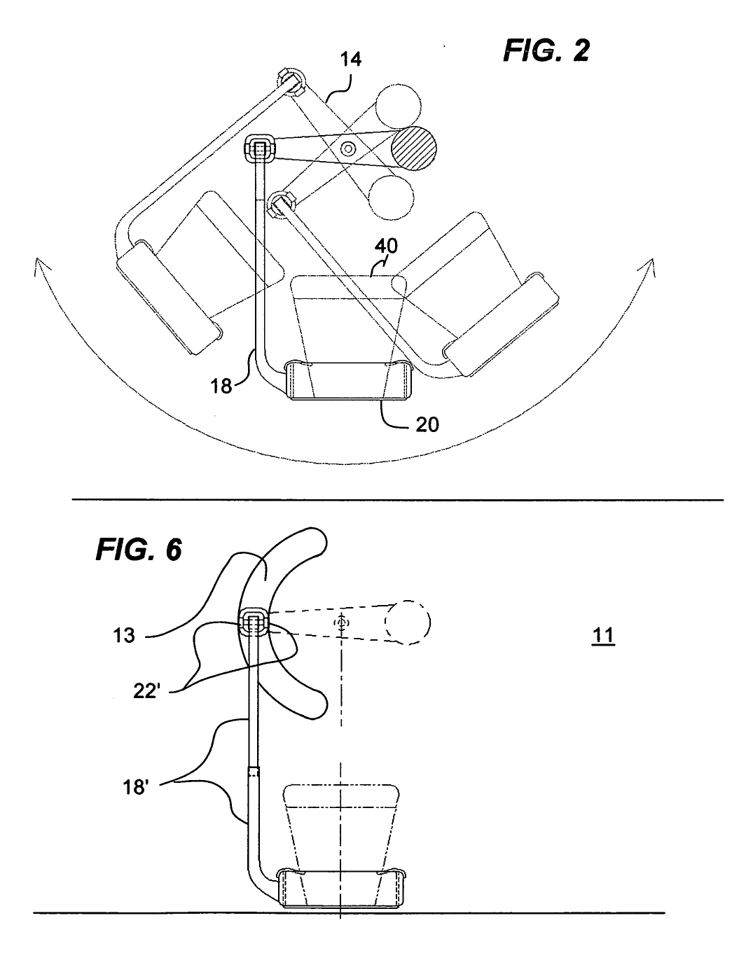

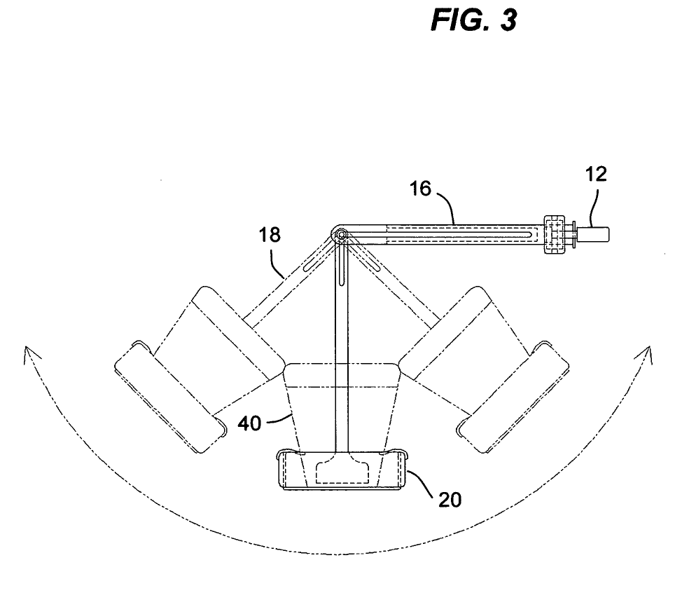

### DETAILED DESCRIPTION

A self-leveling cup holder (10) has an anchoring means (12) so that it can be anchored to a suitable surface inside a vehicle. Generally, such a suitable surface would be the dashboard (11) but it can also be a door or some other side surface for use by passengers, especially in the rear seat.

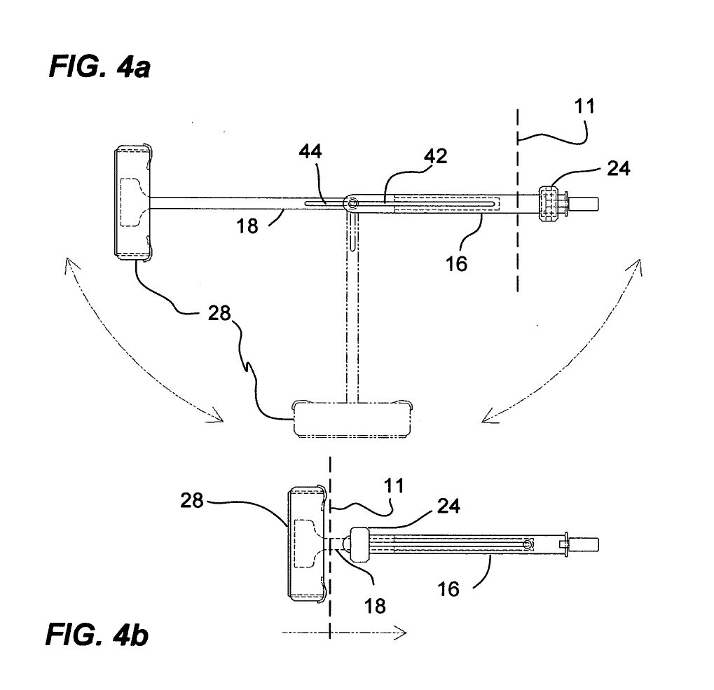

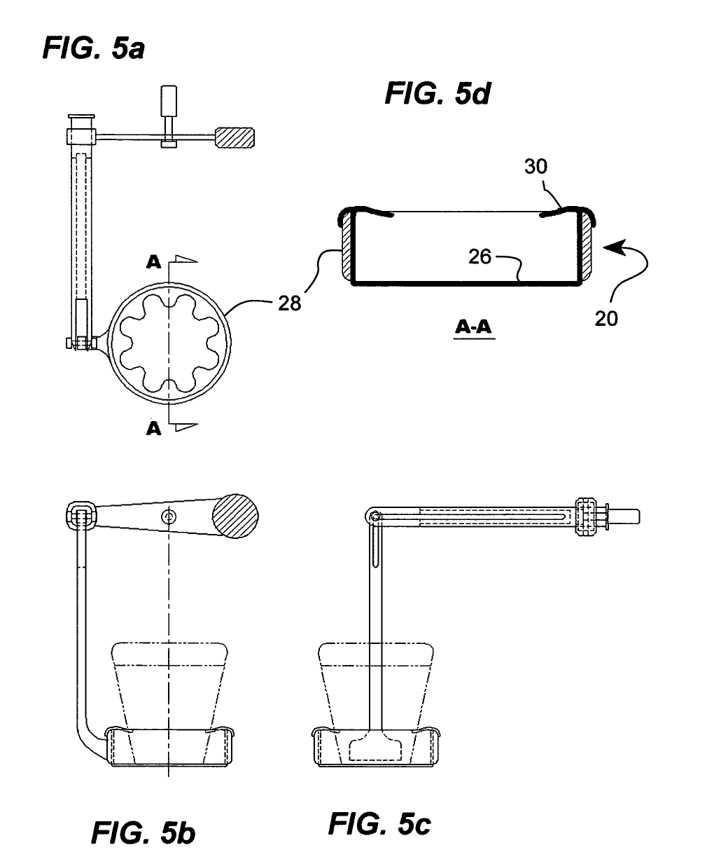

From that anchoring means (12) is rotationally and perpendicularly attached a first axis arm (14) and from that first axis arm (14) extends perpendicularly a sheath (16) into which can be inserted a second axis arm (18). From that second axis arm (18) extends integrally and perpendicularly a cup support (20). The second axis arm (18) is rotationally and perpendicularly attached to the sheath (16) and by turning it around its second axis rotational axis pins (23′) which are located at the second axis arm's rotational axis (23) and orienting the second axis arm (18) so that it is in line with the sheath (16), it can be pushed into the sheath (16) by sliding through a channel (42) so as to be stowed away when not required. To further hide the self-leveling cup holder (10) when, for example, it is located on the dashboard (11) and is a car manufactured installed self-leveling cup holder (10), the sheath (16) can slide through the sleeve (25) which allows the self-leveling cup holder (10) to be practically entirely hidden, especially if the first axis arm (14) and a counterweight (24) are located behing the dashboard (11). In such a retracted configuration, as shown in FIG. 4b, only the (28) is visible and it can even be recessed into the dashboard (11) so that a cover (not shown) could hide it. The recess could be of a size that allows for a user's finger to grasp the (28) and pull it out. In such an in-dashboard configuration, in order for the self-leveling cup holder (10) to be able to rotate around a first axis rotational axis point (22), a slit opening (13) is made through the dashboard (11). Although this could be done after market, it is easily understood that such drastic measures should only be attempted by the boldest of hobbyist since thre is no guarantee that making such an opening to introduce an object such as the self-leveling cup holder (10) implies that there are no components hidden behind the dash and that it does not interfere with anything in front of the dashboard (11) as well.

The first axis arm (12) has two extremities (11, 13) at one extremity (11) is the sheath (16) and at the opposite extremity (13) is the counterweight (24) to balance off the cup support (20). The first axis arm (12) rotates around its first axis rotational axis point (22) which extends integrally from the anchoring means (12).

The anchoring means (12) can come in many guises. A first example is of a cylindrical shape configured and sized to fit into a cigarette lighter hole (not shown) this is ideal when the self-leveling cup holder (10) is sold as an after market item. Alternatively, the anchoring means (12) can be made off at least one clipping means (12′) configured for air vents (not shown) or it can come in the shape of a bolt-down plate (12″).

The cup support (20) has a bottom (26), a circular side (28) and a squeezing means (30) designed to frictionally hold a cup (40) in place, this part of the technology is well known in the art and not be further discussed here.

The second axis arm (18) can optionally be made extendable, so as to accomodate a variety of cup (40) heights, by sliding in and out by way of an extension arm (44) which can be adjusted to a desired length.

As to a further discussion of the manner of usage and operation of the present invention, the same should be apparent from the above description, such as its use on a variety of vehicles such as boats or RV. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A self-leveling cup holder comprising:
an anchoring means and said anchoring means being rotationally and perpendicularly attached to a first axis arm;
a sheath extending perpendicularly from said first axis arm;
a second axis arm rotationally and perpendicularly attached to said sheath;
a cup support extending integrally and perpendicularly from said second axis arm;
said cup support being so positioned so as to provide for a cup to have its center of gravity below said first axis arm and below said second axis arm's rotational axis;
said first axis arm having a first and a second extremity and at said first extremity is said sheath and at said second and opposite extremity is a counterweight to balance off said cup support;
said first axis arm rotating around a first axis rotational axis point;
said first axis rotational axis point extending integrally from said anchoring means.

2. A self-leveling cup holder comprising:
an anchoring means and said anchoring means being rotationally and perpendicularly attached to a first axis arm;
a sheath extending perpendicularly from said first axis arm wherein said sheet being slidingly attached to said first axis by way of a sleeve;
said sleeve being an integral part of said first axis arm;
a second axis arm rotationally and perpendicularly attached to said sheath;
said second axis arm being insertable into said sheath by sliding through a channel;
a cup support extending integrally and perpendicularly from said second axis arm;
said cup support being so positioned so as to provide for a cup to have its center of gravity below said first axis arm and below said second axis arm's rotational axis;
said first axis arm having a first and a second extremity and at said first extremity is said sheath and at said second and opposite extremity is a counterweight to balance off said cup support;
said first axis arm rotating around a first axis rotational axis point;
said first axis rotational axis point extending integrally from said anchoring means.

3. A self-leveling cup holder as in claim 1 wherein:
said anchoring means being a cylindrical shape configured and sized to fit into a cigarette lighter hole.

4. A self-leveling cup holder as in claim 1 wherein:
said anchoring means being at least one clipping means configured for air vents.

5. A self-leveling cup holder as in claim 1 wherein:
said anchoring means being in the shape of a bolt-down plate.

6. A self-leveling cup holder as in claim 1 wherein:
said second axis arm being extendable by sliding in and out by way of an extension channel.

7. A self-leveling cup holder as in claim 2 wherein:
said second axis arm being rotationally and perpendicularly attached to said sheath and said sheath having a channel for guiding and allowing insertion of said second axis and said second axis rotational axis pins into said sheath.

8. A self-leveling cup holder as in claim 2 wherein:
said anchoring means being a cylindrical shape configured and sized to fit into a cigarette lighter hole.

9. A self-leveling cup holder as in claim 2 wherein:
said anchoring means being at least one clipping means configured for air vents.

10. A self-leveling cup holder as in claim 2 wherein:
said anchoring means being in the shape of a bolt-down plate.

11. A self-leveling cup holder as in claim 2 wherein:
said second axis arm being extendable by sliding in and out by way of an extension channel.

12. A self-leveling cup holder as in claim 2 having the following method of use:
turning said second axis arm around its second axis rotational axis point and orienting it so that it is in line with said sheath;
pushing said second axis into said sheath by sliding said second axis through said channel.
